(19) United States
(12) Patent Application Publication
(10) Pub. No.: US 2016/0319804 A1
(43) Pub. Date: Nov. 3, 2016

(54) MICROCHANNEL SOLAR ABSORBER

(71) Applicant: Elwha LLC, Bellevue, WA (US)

(72) Inventors: Roderick A. Hyde, Redmond, WA (US); Jordin T. Kare, San Jose, CA (US); David B. Tuckerman, Lafayette, CA (US); Thomas A. Weaver, San Mateo, CA (US); Lowell L. Wood,, Jr., Bellevue, WA (US)

(73) Assignee: ELWHA LLC, Bellevue, WA (US)

(21) Appl. No.: 14/698,573

(22) Filed: Apr. 28, 2015

(51) Int. Cl. F03G 6/04; F03G 6/06; F24J 2/52; F24J 2/20; F24J 2/48

(52) U.S. Cl. CPC F03G 6/04; F24J 2/202; F24J 2/485; F24J 2/52; F03G 6/06

(57) ABSTRACT

A solar absorber includes a panel having an outer surface configured to absorb an incident concentrated broad spectrum visible solar radiation, an inlet port, an outlet port, and a plurality of channels defined within the panel that form a flow path between the inlet port and the outlet port. The plurality of channels are sized to facilitate laminar flow of a working fluid therethrough.

### BACKGROUND

Solar energy systems utilize sunlight to generate electricity, heat water, or perform other functions. Concentrated solar power systems (e.g., concentrating solar power systems, concentrated solar thermal systems, etc.) use collectors to focus sunlight from a large area onto a smaller area. A receiver (e.g., a solar absorber and related structure) positioned at the smaller area heats a working fluid, which may be a liquid or a gas, and the heated working fluid is utilized to generate electricity, heat water, or perform still other tasks.

The absorber is heated by sunlight and then transfers heat into the working fluid as the fluid flows through or over the absorber. In some cases, the absorber is configured to contain the fluid, as in, e.g., a pipe or an array of pipes. Traditionally, the working fluid is directed through the absorber at a velocity that produces turbulent flow. In turbulent flow, heat transfer from the absorber surface into the fluid is limited by heat conduction through the fluid boundary layer, which decreases in thickness and therefore in thermal resistance as the flow velocity increases. However, high fluid velocities require high pumping power to force fluid through the absorber. Heat transfer can be increased by increasing the temperature difference between the absorber's inner surface and the working fluid. However, a higher absorber temperature requires the use of higher-temperature materials in the absorber and associated structure, and increases reradiation and convective losses from the absorber surface; reradiation in particular increases at the absorber surface temperature to the 4th power. There is also a temperature drop from the outer surface of the absorber that is exposed to sunlight to the inner surface, which is in contact with the absorber. The interaction of these effects tends to limit the maximum working fluid temperature of a solar energy system, reduce the system efficiency, and increase the receiver size and cost.

Some traditional concentrated solar energy receivers attempt to improve the receiver performance by using a transparent window. The window can reduce convective heat losses from the absorber surface, and, by reflecting long-wavelength infrared light back to the absorber, reduce radiative losses. In some cases, the working fluid is not contained by the absorber but is contained by the receiver chamber, including the window, and flows around or through the absorber; this can eliminate the temperature drop due to heat conduction through the absorber wall. However, the windows experience a large solar flux, leading to premature failure of these components. Windows also reflect a significant amount of the incident flux, up to 4% per surface, and may require regular cleaning to prevent accumulation of absorbing dust or other contaminants on the window surface.

### SUMMARY

One embodiment relates to a solar absorber that includes a panel having an outer surface configured to absorb an incident concentrated broad spectrum visible solar radiation, an inlet port, an outlet port, and a plurality of channels defined within the panel that form a flow path between the inlet port and the outlet port. The plurality of channels are sized to facilitate laminar flow of a working fluid therethrough.

Another embodiment relates to a solar receiver that includes a frame, an inlet manifold, an outlet manifold, and an absorber. The absorber includes a first panel coupled to the frame, the first panel having an outer surface configured to absorb an incident concentrated broad spectrum visible solar radiation, and a second panel coupled to the frame, the second panel having an outer surface configured to absorb the incident concentrated broad spectrum visible solar radiation. The first panel defines a plurality of channels, and the second panel defines a plurality of channels. The first panel and the second panel each have an inner end that is coupled to the outlet manifold and an outer end that is coupled to the inlet manifold. The first panel and the second panel are arranged in a V-shaped orientation thereby reducing radiative heat loss.

Still another embodiment relates to a solar heating system for increasing the temperature of a fluid that includes a solar receiver configured to convert an incident concentrated broad spectrum visible solar radiation into thermal energy, a piping system, and a gas turbine. The solar receiver includes a frame, an absorber including a panel coupled to the frame, the panel having an outer surface configured to absorb the incident concentrated broad spectrum visible solar radiation. The panel defines a plurality of channels that are sized to facilitate laminar flow of a working fluid therethrough. The piping system includes an inlet manifold coupled to the solar receiver and configured to provide a gas input thereto and an outlet manifold coupled to the solar receiver and configured to receive a gas output therefrom, the piping system and the plurality of channels defining a flow path. The gas turbine is coupled to the outlet manifold of the piping system and configured to convert the gas output into electricity.

Yet another embodiment relates to a method of manufacturing a solar absorber that includes providing a panel having an outer surface configured to absorb an incident concentrated broad spectrum visible solar radiation, defining an inlet port in the panel, defining an outlet port in the panel, and providing a plurality of channels within the panel that form a flow path between the inlet port and the outlet port. The plurality of channels are sized to facilitate laminar flow of a working fluid therethrough.

Another embodiment relates to a method of manufacturing a solar receiver that includes providing a frame, providing an inlet manifold, providing an outlet manifold, and coupling an absorber to the frame. The absorber includes a first panel coupled to the frame, the first panel having an outer surface configured to absorb an incident concentrated broad spectrum visible solar radiation, and a second panel coupled to the frame, the second panel having an outer surface configured to absorb the incident concentrated broad spectrum visible solar radiation. The first panel defines a plurality of channels, and the second panel defines a plurality of channels. The first panel and the second panel each have an inner end that is coupled to the outlet manifold and an outer end that is coupled to the inlet manifold. The first panel and the second panel are arranged in a V-shaped orientation thereby reducing radiative heat loss.

Another embodiment relates to a method of increasing the temperature of a fluid with a solar heating system. The method includes providing a solar receiver configured to convert an incident concentrated broad spectrum visible solar radiation into thermal energy, providing a piping system having an inlet manifold and an outlet manifold coupled to the solar receiver, applying a gas input to the inlet manifold, the piping system and the plurality of channels defining a flow path, receiving a gas output from the outlet manifold, and converting the gas output into electricity with a gas turbine that is coupled to the outlet manifold of the piping system. The solar receiver includes a frame and an absorber including a panel coupled to the frame, the panel having an outer surface configured to absorb the incident concentrated broad spectrum visible solar radiation. The panel defines a plurality of channels that are sized to facilitate laminar flow of a working fluid therethrough.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1a-1b are schematic views of a solar power tower system, according to one embodiment.

FIG. 2 is a schematic view of a trough-type solar collector system, according to one embodiment.

FIG. 3 is a schematic view of a dish-type solar collector system, according to one embodiment.

FIG. 4a is an elevation view of a solar absorber, according to one embodiment.

FIGS. 4b-4c are cross-sectional views of a solar absorber, according to one embodiment.

FIG. 5 is an elevation view of a tubular solar absorber, according to one embodiment.

FIG. 6 is an elevation view of a tubular solar absorber having lateral passages, according to one embodiment.

FIG. 7a is an elevation view of a tubular solar absorber having passages along a longitudinal axis thereof, according to one embodiment.

FIG. 7b is a detail view of a plate for a solar absorber having a plurality of passages coupled by internal manifolds, according to one embodiment.

FIG. 8 is an elevation view of a portion of a receiver having a tubular shape and constructed with absorbers having passages along a longitudinal axis, according to another embodiment.

FIG. 9 is an elevation view of panels for a solar absorber, according to one embodiment.

FIG. 10 is a schematic view of a solar absorber having panels arranged in a V-shaped orientation, according to one embodiment.

FIG. 11 is an elevation view of a conical solar absorber, according to one embodiment.

FIGS. 12-13 are schematic views of solar absorbers, according to other embodiments.

FIGS. 14a-14c are schematic views of generation systems, according to various embodiments.

FIG. 15 is a schematic view of an energy flow diagram for a generation system, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The solar absorbers disclosed herein provide greater efficiency than traditional solar power absorbers such as those used as part of traditional concentrated solar power systems. The solar absorbers may also at least one of provide a greater fluid temperature and reduce the pressure drop and pumping work requirement relative to traditional solar power absorbers. The temperature of a working fluid is increased as it flows through small-diameter passages (i.e., microchannels, etc.) within the solar absorber. The solar absorber provides a large heat transfer into a working fluid flowing at a low flow velocity (e.g., relative to traditional microchannel absorber designs, etc.). According to one embodiment, the flow velocity and size of the passages are specified to produce laminar flow of the working fluid through the solar absorber. The size of the passages may also be specified to reduce the pressure drop of the working fluid as it flows through the microchannel absorber, thereby further increasing the efficiency of the solar absorber.

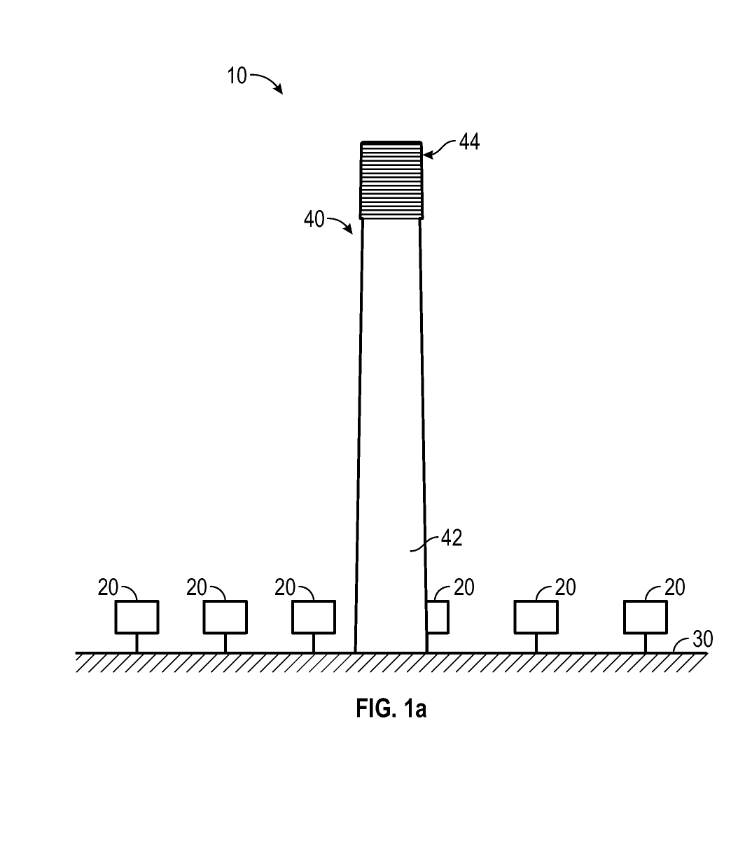

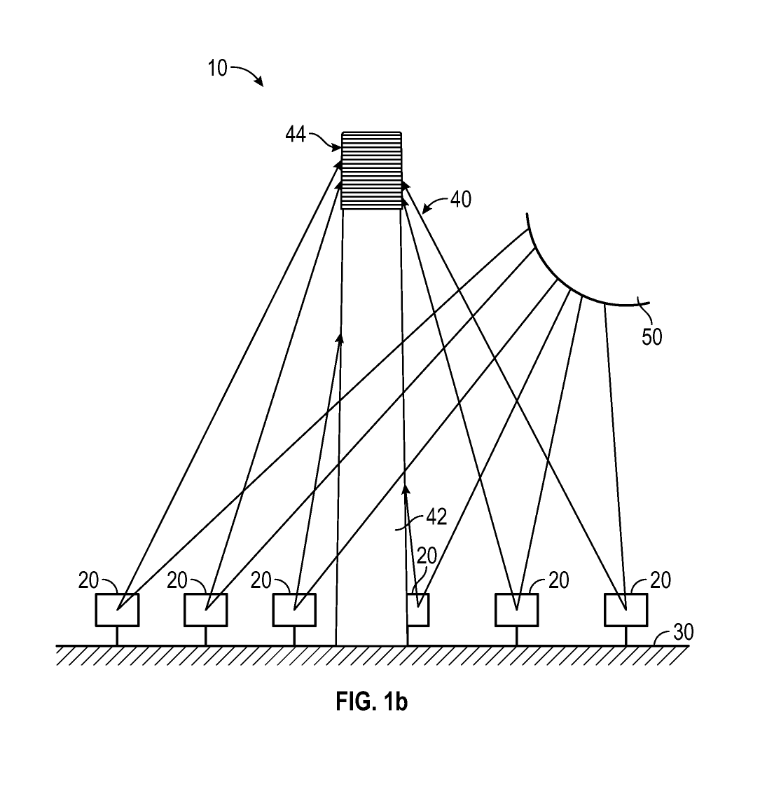

Referring first to the embodiment shown in FIGS. 1a-1b, a solar power system, shown as solar power tower system 10, includes a plurality of directing surfaces, shown as heliostats 20, coupled to ground interface 30. According to one embodiment, solar power tower system 10 utilizes solar energy to heat a working fluid as part of an electrical power generation system. As shown in FIG. 1b, heliostats 20 reflect incident sunlight from sun 50 toward a focal region. As shown in FIG. 1a, solar power tower system 10 includes receiver tower 40. According to one embodiment, receiver tower 40 includes a solar power receiver, shown as solar power receiver 44, elevated above the ground by supporting structure 42. Supporting structure 42 may enclose pipes, tanks, or other components coupled to solar power receiver 44. According to the embodiment shown in FIG. 1b, supporting structure 42 positions solar power receiver 44 in a location where heliostats 20 can focus incident sunlight over a large part of each day at any time of year. According to one embodiment, solar power receiver 44 includes an absorber (e.g., a microchannel absorber, etc.).

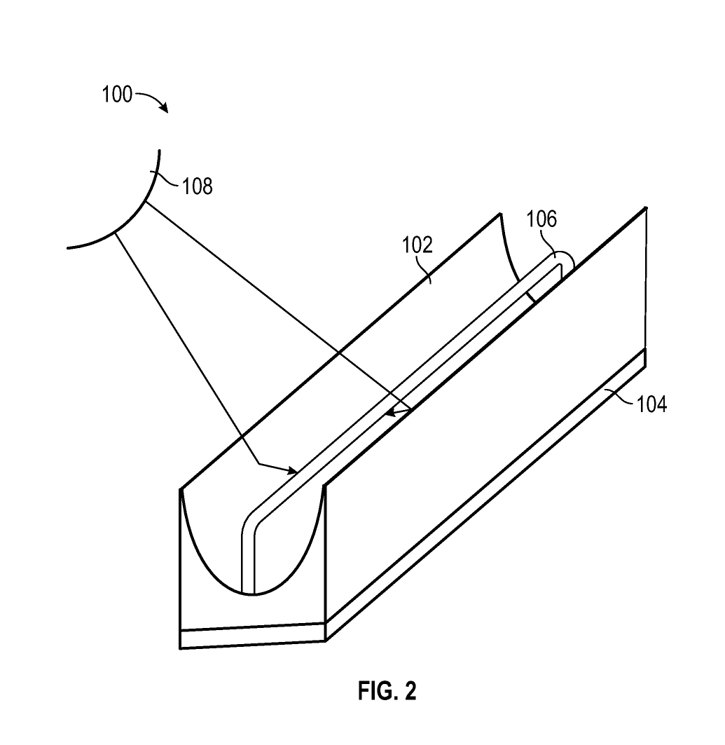

According to the embodiment shown in FIG. 2, a solar system, shown as trough solar power system 100, includes a linear solar collecting structure 102, coupled to a support, shown as support frame 104. As shown in FIG. 2, linear solar collecting structure 102 includes a mirror having a parabolic cross-sectional shape and extending along the length of support frame 104. Linear solar collecting structure 102 concentrates incoming sunlight from sun 108 onto a linear region. Linear solar collecting structure 102 may alternatively have another cross-sectional shape or construction, e.g., a focal concentrator, a linear Fresnel-lens concentrator, a two-reflector Cassegrain concentrator, etc. In some embodiments, linear solar collecting structure 102 may be oriented East-West, and support frame 104 may be configured to orient linear solar collecting structure 102 toward the correct solar elevation as a function of the time of year. In some embodiments, linear solar collecting structure 102 may be oriented generally north-south, and support frame 104 may be configured to orient collecting structure to follow sun 108 over the course of a day.

According to one embodiment, trough solar power system 100 includes a solar absorber that is positioned along the focal line of linear solar collecting structure 102, shown as microchannel absorber tube 106 (i.e., microchannel absorber pipe, etc.). A working fluid may be directed through microchannel absorber tube 106 as part of trough solar power system 100. As incident sunlight is focused by linear solar collecting structure 102, energy is transferred into the working fluid through the wall of microchannel absorber tube 106. The transfer of energy increases the temperature of the working fluid as it travels from a first end to a second end of microchannel absorber tube 106. According to one embodiment, microchannel absorber tube 106 defines a microchannel absorber.

Referring next to the embodiment shown in FIG. 3, a solar system, shown as dish solar power system 110, includes a collecting surface, shown as reflector 112. According to one embodiment, reflector 112 is dish shaped (i.e., in the shape of a depression, cup shaped, etc.) such that incident sunlight from sun 114 reflects toward a focal region. As shown in FIG. 3, incident sunlight is reflected by reflector 112 toward a solar receiver that includes a solar absorber, shown as microchannel absorber 116. Microchannel absorber 116 receives a working fluid through an inlet, transfers energy from sunlight into the working fluid, and provides the heated working fluid to another portion of dish solar power system 110. According to one embodiment, microchannel absorber 116 is positioned at the focal region of reflector 112 (e.g., to increase the rate of energy transfer into the working fluid). Microchannel absorber 116 is positioned by support 118.

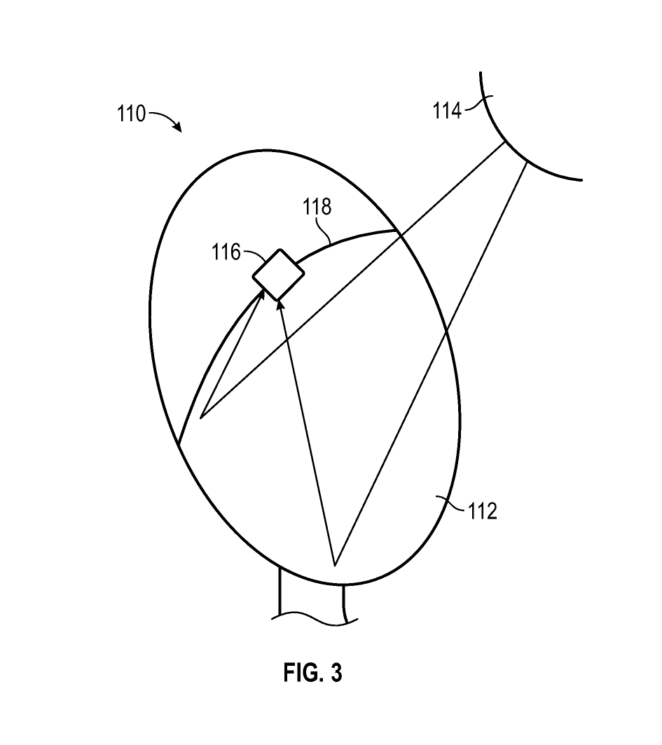

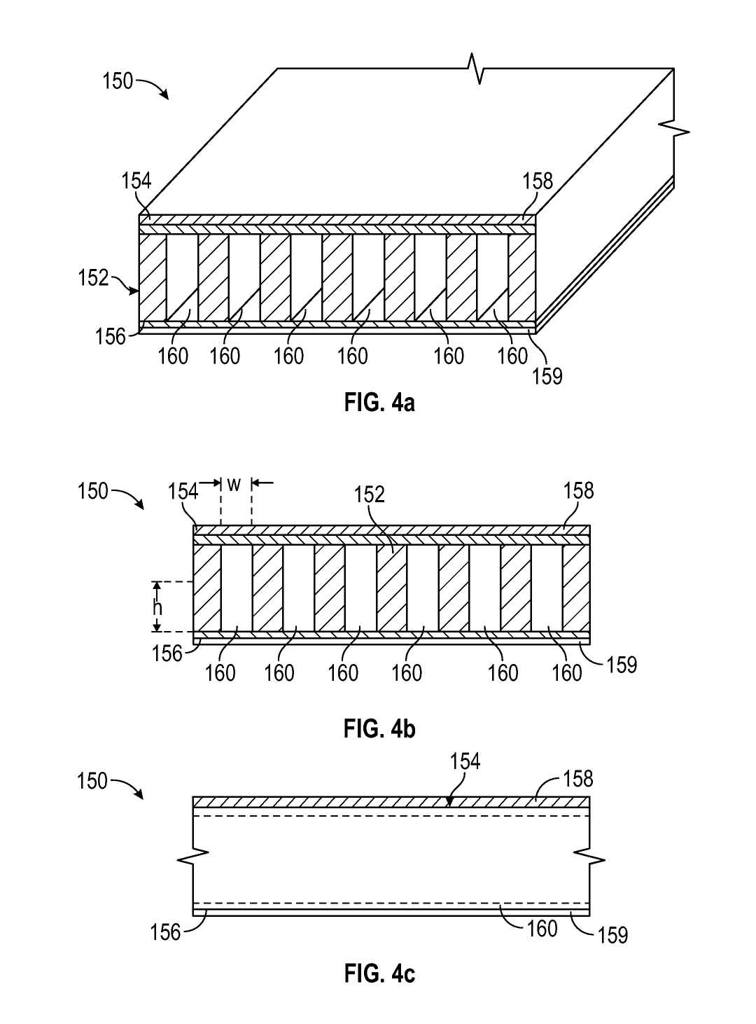

Referring next to the embodiment shown in FIG. 4a-4c, a solar absorber, shown as microchannel absorber 150 includes a panel, shown as plate 152. According to one embodiment, plate 152 is flat. According to another embodiment, plate 152 is curved or has another shape. Plate 152 may be manufactured from a ceramic (e.g., silicon carbide, etc.), a ceramic composite, or a metal (e.g., tungsten, etc.). As shown in FIGS. 4a-4c, plate 152 includes a first surface, shown as first outer surface 154, and a second surface, shown as second outer surface 156. According to one embodiment, microchannel absorber 150 includes an outer layer, shown as coating 158, disposed along first outer surface 154. As shown in FIGS. 4a-4c, microchannel absorber 150 includes an insulation layer, shown as insulation layer 159, disposed along second outer surface 156.

As shown in FIGS. 4a-4c, channels (i.e., tubes, pipes, passages, canals, etc.), shown as channels 160, are defined within a central volume of plate 152. In one embodiment, channels 160 are formed into plate 152 (e.g., using electrical discharge machining, etc.). In other embodiments, plate 152 includes a top surface plate, a bottom surface plate, and a plurality of walls that are coupled together to define channels 160. Channels 160 may provide a plurality of parallel flow paths through microchannel absorber 150. A working fluid (e.g., air, water, oil, molten salt, etc.) may be disposed within channels 160 and receive energy from incident sunlight. As shown in FIG. 4a, plate 152 defines six channels 160 arranged in a one by six rectangular array. According to another embodiment, plate 152 defines more or fewer channels 160.

As shown in FIG. 4c, channels 160 extend along the length of microchannel absorber 150. Channels 160 may alternatively extend only partially along the length of the microchannel absorber 150. According to one embodiment, the lengths of channels 160 are between one and three centimeters. According to another embodiment, the lengths of channels 160 are between three and thirty centimeters (e.g., ten centimeters, etc.). According to yet another embodiment, the lengths of channels 160 are greater than thirty centimeters (e.g., between thirty and 100 centimeters, etc.).

In some embodiments, microchannel absorber 150 includes channels 160 having a cross-sectional shape and dimensions that facilitate the flow of a working fluid therethrough. According to one embodiment, the fluid flow through channels 160 is laminar (e.g., has a Reynolds number of less than 2300). As shown in FIG. 4b, channels 160 each have a rectangular cross-sectional shape defined by a height “h” and a width “w.” In other embodiments, at least one channel 160 has another cross-sectional shape (e.g., trapezoidal, triangular, oval, etc.). In still other embodiments, at least one channel 160 is subdivided or filled with “wool.” Channels 160 may have a width of less than one millimeter (e.g., 0.2 millimeters, etc.) and a height of less than two millimeters (e.g., 1.5 millimeters, etc.). By way of example, such channels 160 may facilitate laminar flow of a gaseous working fluid (e.g., air, nitrogen, helium, etc.). In another embodiment, channels 160 have a smaller width and height. By way of example, smaller channels 160 may facilitate laminar flow of a liquid working fluid (e.g., oil, molten salt, etc.). A cross-sectional aspect ratio is defined as the ratio of height h to width w. According to one embodiment, the cross-sectional aspect ratio of channels 160 is greater than one. According to another embodiment, the cross-sectional aspect ratio of channels 160 is between three and ten. In some embodiments, the aspect ratio and spacing of channels 160 are selected to reduce (e.g., minimize, etc.) the thermal resistance between a top surface of plate 152 and the working fluid. In other embodiments, the aspect ratio and spacing of channels 160 are selected to optimize some weighted combination of design parameters. Such design parameters may include fluid flow resistance, temperature drop in the solid materials, thermal resistance from the solid surface into the fluid, mass or volume of solid materials used, or mass or volume of fluid in the absorber, among others. Reducing the thermal resistance between the top surface of plate 152 and the working fluid will, for any given fluid temperature and incident solar flux, also reduce (e.g., minimize, etc.) the surface temperature of microchannel absorber 150 and therefore the thermal reradiation from the absorber surface, which is proportional to T(surface)̂4.

Channels 160 each have a hydraulic diameter. The hydraulic diameter of rectangular channels 160 may be calculated by multiplying the cross sectional area (e.g., width w multiplied by height h) by four and dividing by the wetted perimeter (e.g., two times width w plus two times height h). Corresponding formulas for hydraulic diameter exist for other possible cross-sectional shapes. In one embodiment, the hydraulic diameter of channels 160 for liquid working fluids is about one micron (e.g., order of magnitude one micron, within 0.1 microns, etc.). According to another embodiment, the hydraulic diameter of channels 160 for gaseous working fluids (e.g., air, steam, hydrogen, etc.) is about 0.35 millimeters. In another embodiment, the hydraulic diameter of channels 160 are less than 500 microns.

Referring still to the embodiment shown in FIGS. 4a-4c, coating 158 is disposed along first outer surface 154. According to one embodiment, coating 158 is a broadband absorber of visible and near-infrared wavelengths and positioned to absorb incident sunlight. In one embodiment, coating 158 is a material that re-radiates a relatively small amount (e.g., 10%, etc.) of energy at infrared wavelengths corresponding to the blackbody spectrum peak at the operating temperature of microchannel absorber 150. Coating 158 absorbs energy from the sunlight that travels toward plate 152 (i.e., sunlight is incident upon coating 158, etc.). The position of coating 158 (i.e., along first outer surface 154, etc.) facilitates the transfer of energy (e.g., conductive, convective, etc.) into a working fluid disposed within channels 160. In some embodiments, coating 158 absorbs sunlight but does not re-radiate energy at longer wavelengths, thereby increasing the efficiency of microchannel absorber 150. By way of example, coating 158 may have a low emissivity for wavelengths longer than a cutoff wavelength (e.g., between one and two microns, five microns, etc.). Coating 158 having a low emissivity for wavelengths longer than a cutoff wavelength is optimized for absorbing sunlight above the cutoff wavelength (e.g., visible light having a wavelength less than two microns) thereby reducing blackbody radiation losses. In one embodiment, coating 158 is configured to preferentially absorb sunlight along a particular angle of incidence. By way of example, coating 158 may have at least one of grooves, fins, and hairs shaped to facilitate preferentially absorbing sunlight along the particular angle of incidence. The particular angle of incidence may correspond to angles at which a line of sight between coating 158 and one or more solar collectors can be established.

Insulation layer 159 of microchannel absorber 150 may include a coating (e.g., a ceramic wool, foam, etc.) or another material. Insulation layer 159 is configured to insulate plate 152, thereby reducing energy losses through second outer surface 156 of microchannel absorber 150. Insulation layer 159 may be applied to, disposed along, attached to, or otherwise coupled to second outer surface 156. The thickness of insulation layer 159 may be uniform or variable (e.g., vary along the length of channels 160, otherwise vary with position, etc.). In other embodiments, microchannel absorber 150 does not include insulation layer 159.

The absorbed energy from coating 158 is transmitted to plate 152 through conductive heat transfer. The energy flows to inner surfaces of channels 160, which are defined within plate 152, by conductive heat transfer. Energy may be transmitted (e.g., through forced convection heat transfer, etc.) into the working fluid as it travels through channels 160. In traditional solar absorbers, heat flow from the surface into the working fluid is limited by conduction through a boundary layer. After flowing through the boundary layer, the heat is distributed through the flow volume by turbulence. The thickness of the boundary layer determines the heat transfer coefficient, and the flow rate is traditionally increased to reduce the thickness of the boundary layer. However, increased flow rate also increases the pressure drop across traditional solar absorbers. Laminar flow of the working fluid reduces the pressure drop across microchannel absorber 150. By way of example, the hydraulic diameter of channels 160 may be small such that the boundary layer of the flow through channels 160 occupies the entire width w. The thickness of the boundary layer may be independent of the flow velocity. Accordingly, microchannel absorber 150 may be scaled or the flow rate may be changed to provide a desired heat transfer.

According to one embodiment, first outer surface 154 is configured to absorb incident sunlight. As shown in FIG. 4a, coating 158 is a material applied (e.g., painted, deposited, electroplated, statically applied, etc.) to first outer surface 154 and facilitates absorbing incident sunlight. Coating 158 may be a ceramic, polymer-based, metallic, or still another type of material. According to another embodiment, a surface treatment (e.g., an etching, etc.) is applied to first outer surface 154. By way of example, the surface treatment may have a wavelength-scale roughness. The surface treatment may facilitate absorbing incident sunlight. According to still other embodiments, panel is manufactured from an absorbing material (e.g., graphite, etc.) such that first outer surface 154 is configured to absorb incident sunlight.

Referring still to the embodiment shown in FIGS. 4a-4c, microchannel absorber 150 transfers energy from an incident surface (e.g., a surface of coating 158, first outer surface 154, etc.) to a working fluid disposed within channels 160. Such energy transfer may be achieved through conduction. Channels 160 may extend between an inlet port and an outlet port both coupled to plate 152. The working fluid flows from the inlet port to the outlet port through channels 160. According to one embodiment, the temperature of the working fluid increases as it flows between the inlet port and the outlet port of plate 152. According to one embodiment, incident sunlight interacts with coating 158 and flows toward first outer surface 154. According to another embodiment, incident sunlight interacts with first outer surface 154 (i.e., microchannel absorber 150 may not include coating 158, etc.). A portion of the incident energy (e.g., four percent, etc.) reflects from the incident surface, and a portion of the incident energy (e.g., ninety six percent, etc.) is absorbed.

According to one embodiment, plate 152 is a refractory material. The refractory material may be a metal, a ceramic, glass, or a composite material, among other alternatives. According to another embodiment, the refractory material is a metal-ceramic composite, a fiber-reinforced composite, or still another material. In some embodiments, the portion of plate 152 defining first outer surface 154 is semi-transparent (e.g., to visible light, to infrared sunlight, etc.) and thereby transmits some portion of incident sunlight. A plurality of dividers that define channels 160 may also be transparent. Other plates or coating 158 may also be transparent and transmit some portion of incident sunlight. In one embodiment, plate 152 is at least semi-transparent, and microchannel absorber 150 includes coating 158 that is an anti-reflective coating. The anti-reflective coating reduces the percentage of incident sunlight that reflects off of coating 158 (e.g., to facilitate the transmission of energy into the central volume of plate 152, to reduce the energy reflected off of coating 158, etc.). The transmitted sunlight may be absorbed by another portion of plate 152 (e.g., a plurality of dividers that form channels 160, the working fluid, the portion of plate 152 defining the second outer surface 156, etc.). In one embodiment, the working fluid is opaque (e.g., to facilitate direct energy deposition, etc.). The light energy thereby travels further down into microchannel absorber 150 to reduce or eliminate the distance the heat needs to travel to reach the working fluid (i.e., the microchannel absorber 150 may deposit the heat closer to or directly within the working fluid, etc.). According to another embodiment, plate 152 is opaque and configured to absorb incident energy.

According to one embodiment, microchannel absorber 150 having plate 152 and coating 158 has an increased absorptivity. While the material of plate 152 may have a preferred level of mechanical strength, a preferred nonporous surface, or another feature, it may lack various other desired characteristics (e.g., reflectivity in the visible spectrum, reflectivity in the infrared spectrum, etc.). In one embodiment, coating 158 includes a material that is at least one of black (i.e., high absorptivity) in the visible spectrum and white (i.e., low emissivity) in the infrared spectrum. The composite arrangement of microchannel absorber 150 may thereby have a preferred level of mechanical strength while also having desired absorption characteristics.

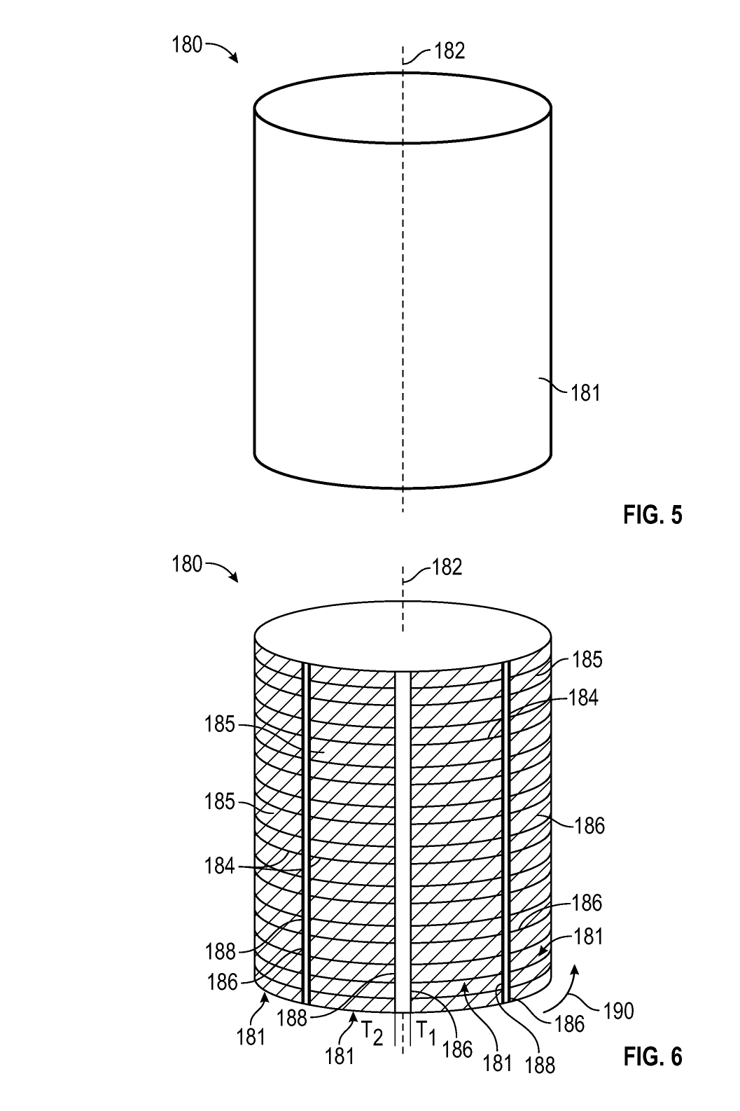

Referring next to the embodiment shown in FIG. 5, a solar absorber, shown as microchannel absorber 180, for a solar receiver has a panel, shown as plate 181. As shown in FIG. 5, plate 181 is formed as a tubular member and has an annular cross-sectional shape. Plate 181 may be curved and shaped as a portion of a tubular structure (e.g., in the shape of an arc, in the shape of an annular ring, etc.), and microchannel absorber 180 may include a plurality of plates 181. As shown in FIG. 5, microchannel absorber 180 defines longitudinal axis 182. According to one embodiment, plate 181 of microchannel absorber 180 is positioned such that the center of the annular cross-sectional shape is positioned at longitudinal axis 182. According to another embodiment, microchannel absorber 180 includes a rectangular cross-sectional shape. According to still other embodiments, microchannel absorber 180 is otherwise shaped (e.g., irregularly shaped, etc.). Plates 181 may extend across the full width, around the full circumference, or otherwise form a complete structure of microchannel absorber 180. In other embodiments, microchannel absorber 180 includes a plurality of plates 181 that are tiled to form the full width, full circumference, or other complete structure of microchannel absorber 180. Microchannel absorber 180 may cover the entire solar receiver structure or only a part of it. By way of example, microchannel absorber 180 may cover the entire area of the solar receiver structure that sunlight hits or only a portion of the solar receiver structure that receives higher-flux incident sunlight. In some embodiments, the solar receiver includes an actuator configured to selectively reposition microchannel absorber 180 into a target orientation. In other embodiments, the solar receiver includes a flow device (e.g., solenoid-actuated valve, etc.) positioned to selectively reconfigure (e.g., switch, etc.) a flow path associated with the working fluid such that the working fluid flows only though target portions of microchannel absorber 180.

Microchannel absorber 180 is shaped to absorb energy as part of a solar energy system. According to one embodiment, microchannel absorber 180 is configured to be integrated within the solar receiver and placed atop a positioning system (e.g., a tower, etc.) as part of a concentrated solar power tower system. According to another embodiment, microchannel absorber 180 is configured to be integrated within a solar receiver and absorb energy as part of a trough solar power system or a dish solar power system.

According to the embodiment shown in FIG. 6, microchannel absorber 180 includes a plurality of channels (i.e., tubes, pipes, passages, canals, etc.), shown as channels 184. As shown in FIG. 6, channels 184 extend within a plurality of plates 181 of microchannel absorber 180 and circumferentially around longitudinal axis 182 (i.e., laterally across the longitudinal axis, etc.). According to one embodiment, a working fluid disposed within channels 184 flows between a plurality of inlet ports, shown as inlet manifolds 186, and a plurality of outlet ports, shown as outlet manifolds 188, in a direction of flow 190. As shown in FIG. 6, channels 184 each include a first end coupled to one inlet manifold 186 and a second end coupled to one outlet manifold 188 thereby creating a plurality of parallel flow paths. Channels 184 may thereby form both series and parallel flow paths. In other embodiments, microchannel absorber 180 includes only a single plate 181.

Referring still to the embodiment shown in FIG. 6, microchannel absorber 180 increases the temperature of a working fluid within channels 184. According to one embodiment, microchannel absorber 180 includes an outer layer, shown as coating 185, that absorbs energy from incident sunlight. As a working fluid flows through channels 184, microchannel absorber 180 transmits energy into the working fluid. According to one embodiment, a driver (e.g., an axial flow pump, a centrifugal pump, a compressor, etc.) directs the working fluid through channels 184. Microchannel absorber 180 transmits energy through conductive heat transfer from coating 185 to a central portion of plate 181 and through forced convective heat transfer into the working fluid. As shown in FIG. 6, the energy transmitted from microchannel absorber 180 increases the temperature of the working fluid from a temperature T₁ (e.g., 500 degrees Celsius) upon entering one of the inlet manifolds 186 to a temperature T₂ upon exiting one of the outlet manifolds 188. According to one embodiment, temperature T₂ is about 1,000 degrees Celsius (e.g., between 900 and 1,100 degrees Celsius). According to another embodiment, temperature T₂ is greater than 1,000 degrees Celsius.

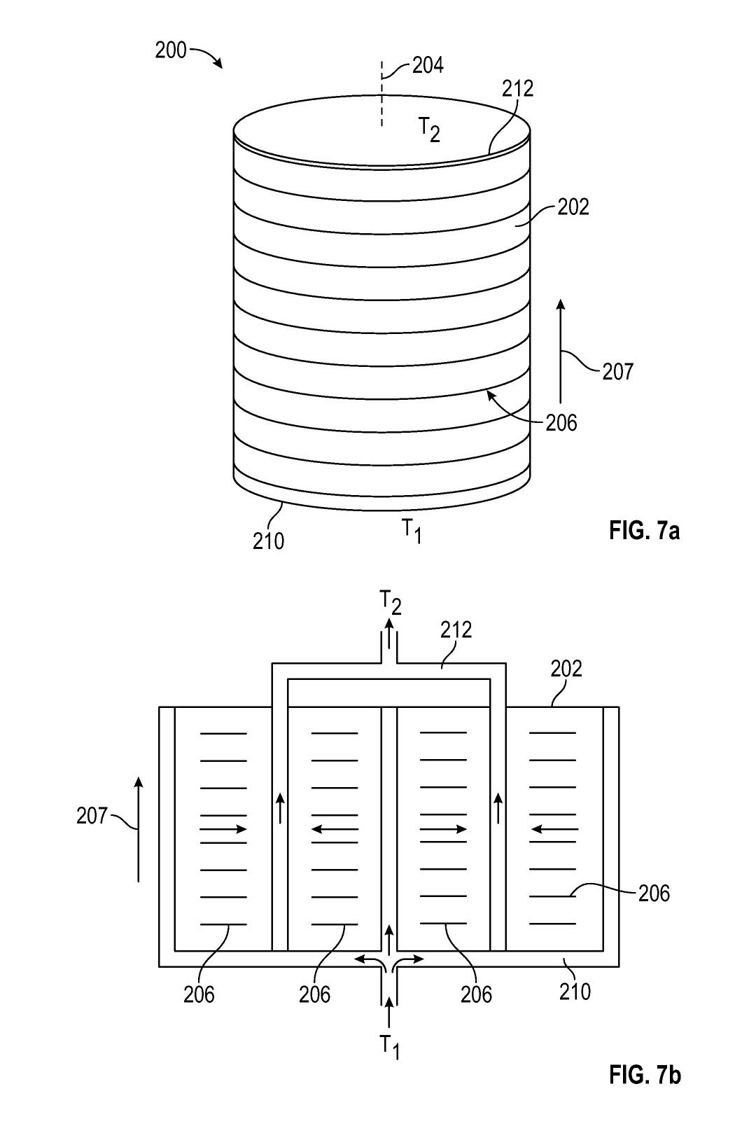

According to the embodiment shown in FIGS. 7a-7b, a solar absorber, shown as microchannel absorber 200, for a solar receiver includes a panel, shown as plate 202, shaped as a cylinder. As shown in FIG. 7, plate 202 defines longitudinal axis 204. According to one embodiment, longitudinal axis 204 extends along a centerline of plate 202. A plurality of passages, shown as channels 206, is defined within a central volume of plate 202. As shown in FIG. 7, channels 206 are defined across longitudinal axis 204 of plate 202. According to another embodiment, channels 206 may extend generally along (i.e., at an angle of less than forty five degrees relative to) longitudinal axis 204. As shown in FIG. 7, microchannel absorber 200 includes a single plate 202. In other embodiments, microchannel absorber 200 includes a plurality of plates 202 (e.g., plates 202 coupled in parallel, plates 202 coupled in series, plates 202 coupled in both series and parallel, etc.).

A working fluid disposed within channels 206 flows along flow direction 207 between inlet port 210 and outlet port 212. Piping or other components may couple channels 206. Energy of sunlight incident on a coating of a first outer surface is transferred into a working fluid to increase the temperature thereof through conductive and convective heat transfer from an initial temperature T₁ to a second temperature T₂.

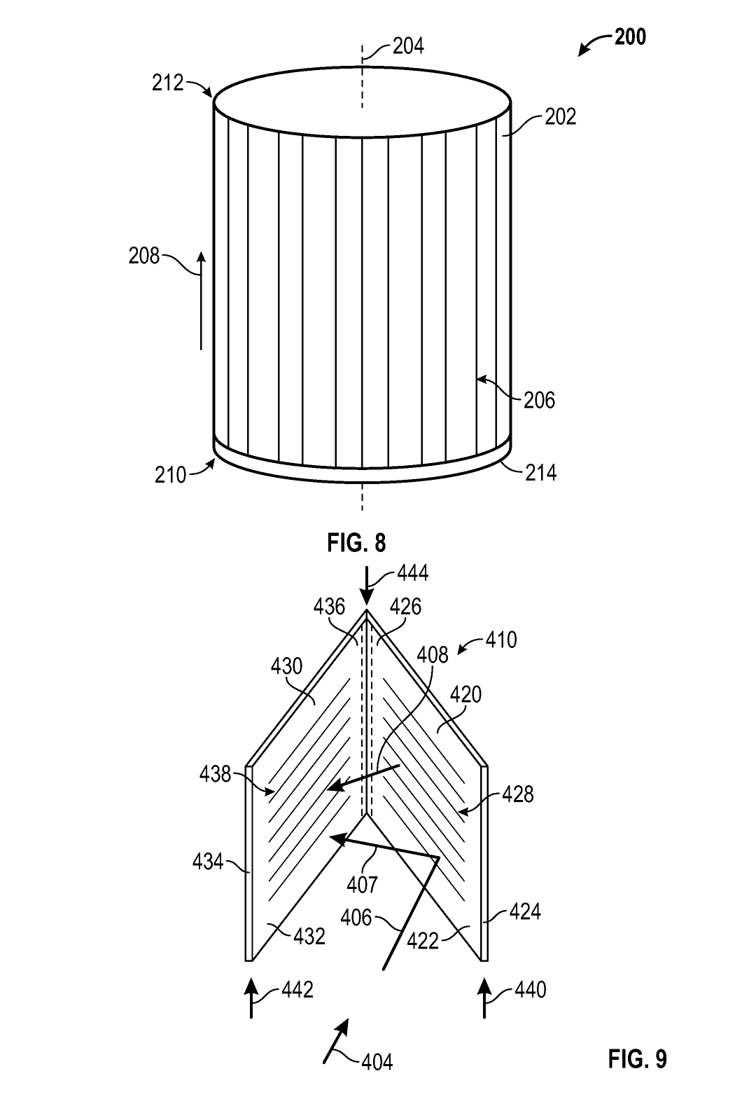

Referring next to the embodiment shown in FIG. 8, microchannel absorber 200 includes plate 202 and channels 206 that form a flow path along longitudinal axis 204. According to one embodiment, a working fluid flows along flow direction 208 from inlet port 210 to outlet port 212. Channels 206 may define flow paths (e.g., along longitudinal axis 204, across longitudinal axis 204, etc.) to facilitate such flow of the working fluid. The working fluid may then flow back toward inlet port 210 (e.g., through a conduit piping system, etc.) for use. In one embodiment, a conduit piping system carrying the working fluid through microchannel absorber 200 is disposed within a cavity formed by plate 202 (e.g., to further reduce energy losses associated with reradiation from the warmer working fluid, etc.). As shown in FIG. 8, microchannel absorber 200 includes a port, shown as manifold 214, coupled to channels 206. According to one embodiment, manifold 214 defines an inlet region coupled to the inlet of each channel 206. Microchannel absorber 200 directs a working fluid into channels 206 through manifold 214.

Referring next to the embodiment shown in FIG. 9, sunlight 404 interfaces with a portion of a solar absorber, shown as plate assembly 410. As shown in FIG. 9, plate assembly 410 includes a first panel, shown as plate 420, and a second panel, shown as plate 430, arranged in a V-shaped orientation (i.e., a pleated configuration, etc.). According to one embodiment, plate 420 and plate 430 each include a central volume and an outer surface, shown as outer surface 422 and outer surface 432, respectively. The front sides (e.g., outer surface 422 and outer surface 432, etc.) of the panels (e.g., plate 420, plate 430, etc.) may be solar-absorbing and face into the V, according to the embodiment shown in FIG. 9. As shown in FIG. 9, plate 420 includes an inlet, shown as manifold 424, and an outlet, shown as manifold portion 426. According to one embodiment, a plurality of passages, shown as channels 428, extend between manifold 424 and manifold portion 426. Plate 430 includes an inlet, shown as manifold 434, an outlet, shown as manifold portion 436, and a plurality of passages, shown as channels 438, extending between manifold 434 and manifold portion 436. According to one embodiment, a working fluid flows along flow direction 440 and flow direction 444, through channels 428 and channels 438, and into manifold portion 426 and manifold portion 436. The open ends of the V are thereby coupled to the inlet, and the closed ends of the V are thereby coupled to the outlet. In other embodiments, channels 428 and channels 438 extend in another direction, and a plurality of internal manifolds distribute and combine the flow of a working fluid between the inlets and the outlets of plate 420 and plate 430 (e.g., in a manner as shown in FIG. 7b, etc.). As shown in FIG. 9, manifold portion 426 and manifold portion 436 are coupled such that the working fluids from plate 420 and plate 430 combine and flow along a common flow direction 444. According to another embodiment, the working fluids from plate 420 and plate 430 flow separately from manifold portion 426 and manifold portion 436.

According to one embodiment, sunlight 404 interfaces with plate 420 and plate 430 as a plurality of incident waves. As shown in FIG. 9, incident wave 406 interfaces with outer surface 422 of plate 420. According to one embodiment, a portion of the energy from incident wave 406 is transmitted into a central volume of plate 420 where it transfers energy into a working fluid. According to another embodiment, plate 420 and plate 430 include an outer layer (e.g., a coating, etc.) disposed along an outer surface (e.g., the incident surface, etc.) to absorb sunlight 404. The outer layer absorbs energy from sunlight 404, which increases the temperature of the working fluid as it travels along channels 428 and channels 438. It should be understood that the energy transfer increases the temperature of the working fluid as it travels from manifold 424 and manifold 434 to manifold portion 426 and manifold portion 436.

As shown in FIG. 9, a portion of the energy is reflected off outer surface 422 (e.g., an outer surface of plate 420, a surface of a coating, etc.) as reflected wave 407. The working fluid within plate 420 radiates energy as radiated wave 408. According to one embodiment, plate assembly 410 is designed such that reflected wave 407 and radiated wave 408 are directed toward plate 430. It should be understood that plate 430 may similarly reflect and re-radiate energy toward plate 420. The working fluid within plate 420 and plate 430 may also re-radiate energy inward (e.g., toward an inner surface of another pleat, inward into the V, etc.). A solar absorber including plate assembly 410 and a flow of working fluid from manifold 424 and manifold 434 toward manifold portion 426 and manifold portion 436 has a greater efficiency than traditional solar absorbers, which may not reflect and radiate energy toward other portions of the receiver. Plate assembly 410 further improves efficiency by positioning working fluid having a greater temperature at a location where a greater percentage of radiated energy is directed toward another portion of plate assembly 410 (i.e., the higher-temperature working fluid is directed toward the narrow end of each V or pleat to reduce the amount of energy that is lost to a surrounding environment, etc.).

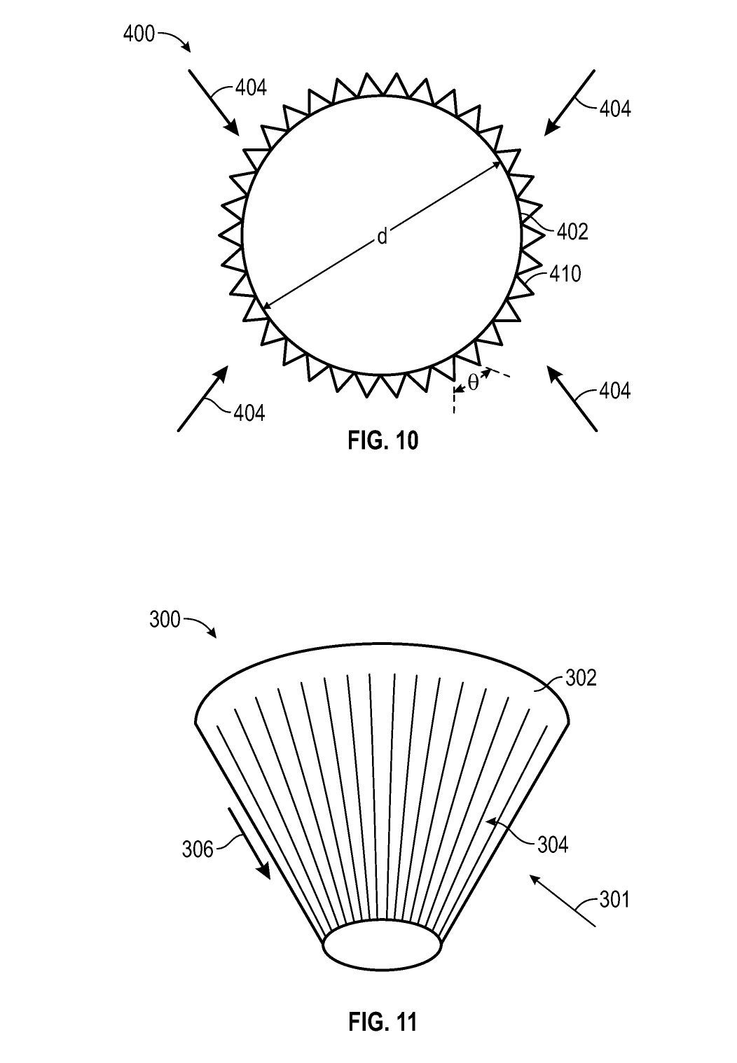

Referring next to the embodiment shown in FIG. 10, a solar receiver, shown as solar receiver 400, includes plate assembly 410 and a support (i.e., frame, etc.), shown as structure 402. In other embodiments, plate assembly 410 is otherwise oriented (e.g., perpendicular to the orientation shown in FIGS. 10-11, around a central axis of solar receiver 400, around a periphery of solar receiver 400, etc.). According to one embodiment, solar receiver 400 reduces energy losses (e.g., those associated with reflection, etc.) by increasing the amount of energy that is absorbed by a working fluid. Structure 402 is cylindrically shaped and defines a longitudinal central axis. According to one embodiment, structure 402 includes frame members arranged as a cylinder having a diameter “d” but allows energy to pass therethrough (i.e., structure 402 may be a space frame or another device). In other embodiments, structure 402 has another shape or has a different diameter.

As shown in the top view of FIG. 10, plate assembly 410 is coupled to structure 402. According to another embodiment, the panels of plate assembly 410 are coupled to one another or to another device. In one embodiment, plate assembly 410 includes a coating disposed along the surfaces of the panels that face into each V, and the coating defines the incident surface that absorbs sunlight. As shown in FIG. 10, the panels of plate assembly 410 are angularly offset from one another at an angle “θ.” According to one embodiment, angle θ is thirty degrees. According to various another embodiments, angle θ is between zero and one hundred and eighty degrees, though the utility (e.g., amount of reradiation captured, etc.) may decrease rapidly as angle θ increases. According to still another embodiment, the panels of plate assembly 410 are otherwise arranged (e.g., the panels are curved and arranged in a wave pattern, etc.). While shown positioned along a cylindrical structure 402, it should be understood that plate assembly 410 may have various shapes (e.g., a cone-shaped microchannel absorber may include a plurality of panels arranged in a V-shaped orientation, etc.). Solar receiver 400 including plate assembly 410 having panels offset at angle θ may have a reduced energy loss from a working fluid within plate assembly 410. In some embodiments, solar receiver 400 includes an inlet manifold and an outlet manifold configured to provide a flow of working fluid to the inlet manifolds and outlet manifolds of panels within plate assembly 410. According to one embodiment, panels of the solar absorber are arranged around only a portion of the periphery of structure 402 (e.g., 180 degrees around a cylindrical structure 402, etc.). According to another embodiment, panels are arranged around the entire periphery of structure 402.

As shown in FIG. 10, sunlight 404 interfaces with solar receiver 400 from various directions. A portion of sunlight 404 reflects off the outer surfaces (i.e., the surface radially outward from a center of structure 402, etc.) of plate assembly 410, and a portion of sunlight 404 is absorbed by plate assembly 410. According to one embodiment, a portion of the energy absorbed by plate assembly 410 re-radiates from the outer surfaces of plate assembly 410, the re-radiated and reflected energy that is not re-absorbed by another portion of solar receiver 400 defining an energy loss.

In one embodiment, at least one of plate 420 and plate 430 include a first subpanel and a second subpanel, the first and the second subpanels each having an inlet and an outlet. The inlet of the first subpanel may be coupled to the inlet manifold of solar receiver 400, the outlet of the first subpanel may be coupled to the inlet of the second subpanel, and the outlet of the second subpanel may be coupled to the outlet manifold of solar receiver 400. The first and second subpanels may thereby be configured in a series arrangement between the inlet manifold and outlet manifold of solar receiver 400. In one embodiment, the first and second subpanels are manufactured from different materials. By way of example, the first subpanel may be manufactured from a first material that is configured to operate (e.g., withstand, work at, etc.) at a first temperature while the second subpanel may be manufactured from a second material configured to operate at a second temperature that is greater than the first temperature. The first subpanel may be positioned further outward than, and experience reduced operating temperatures relative to, the second subpanel. The first subpanel may thereby be manufactured from a less expensive material (e.g., aluminum, etc.) configured to operate at a low temperature while the second subpanel may be manufactured from a more expensive material (e.g., silicon carbide, etc.) configured to operate at greater temperatures. Such an arrangement reduces the cost of solar receiver 400.

Referring next to the embodiment shown in FIG. 11, a solar absorber, shown as microchannel absorber 300, for a solar receiver includes a cone-shaped (i.e., conical, pyramidal, etc.) panel, shown as plate 302. In other embodiments, plate 302 has a “U” shaped profile. Plate 302 may be positioned as part of a solar system such that incident energy from sunlight 301 may be absorbed by plate 302. Plate 302 improves efficiency by reducing the amount of energy that is lost (e.g., through radiation) to a surrounding environment. According to one embodiment, plate 302 defines a plurality of channels (i.e., tubes, pipes, passages, canals, etc.), shown as channels 304, that extend inwardly and along the length of plate 302. As shown in FIG. 11, a working fluid may flow along channels 304 in a direction of flow 306 (i.e., from a wider end of plate 302 toward a narrower end of plate 302). In other embodiments, channels 304 extend laterally across the length of plate 302. One or more manifolds may couple channels 304 such that the working fluid flows along direction of flow 306. According to still another embodiment, passages may be otherwise defined within plate 302 to facilitate a fluid flow in still other directions. Microchannel absorber 300 transfers energy (e.g., from a solar source, etc.) into the working fluid, which increases the temperature thereof. By directing the working fluid toward a narrow end of plate 302, a larger portion of the energy radiated from the higher-temperature working fluid is absorbed by another portion of plate 302. According to another embodiment, the working fluid may flow from the narrow end of plate 302 toward the wider end of plate 302.

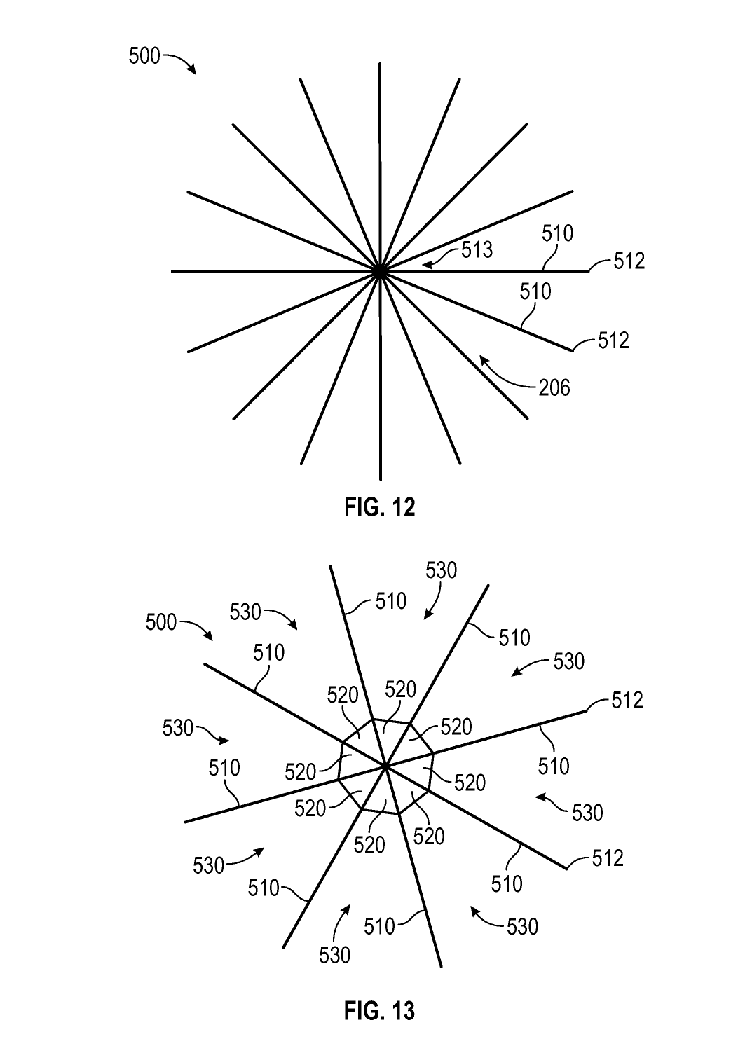

Referring next to the embodiment shown in FIG. 12, a solar absorber, shown as microchannel absorber 500, for a solar receiver includes a plurality of panels, shown as plates 510. According to one embodiment, plates 510 include an inlet end 512, an outlet end 513, and a plurality of microchannels extending therebetween. A working fluid increases in temperature as it flows between inlet end 512 and outlet end 513 of each plate 510. As shown in FIG. 12, outlet ends 513 of plates 510 are coupled and form a common outlet conduit. In some embodiments, a structure of the solar receiver defines a central axis, and the common outlet conduit extends along the central axis. As shown in FIG. 12, inlet ends 512 of plates 510 are positioned radially outward from the central axis relative to outlet ends 513. According to one embodiment, microchannel absorber 500 includes plates 510 positioned to reduce energy losses associated with convection, radiation, and conduction. Directing the working fluid from inlet ends 512 of plates 510 towards a centrally-located outlet end 513 reduces energy losses due to radiation because a larger portion of the radiated energy from the higher-temperature working fluid (e.g., further radially inward, etc.), which radiates more energy than the lower-temperature working fluid, is absorbed by another plate 510.

As shown in FIG. 13, microchannel absorber 500 includes a plurality of baffles, shown as baffles 520. In operation, an energy source (e.g., a solar source, etc.) transfers energy into plates 510, and a fluid flow within the surrounding environment (e.g., wind, a flow due to thermal currents produced by plates 510, etc.) produces convective heat transfer from an outer surface of plates 510. According to the embodiment shown in FIG. 13, baffles 520 are shaped and/or positioned to reduce the convective heat transfer from plates 510. By way of example, baffles 520 may disrupt the flow of air along the length of microchannel absorber 500 (e.g., along the length of plates 510, etc.) thereby reducing the flow rate of fluid in proximity to plates 510 and, in turn, reducing convective heat loss. As shown in FIG. 13, baffles 520 are horizontally positioned and extend within a plane to which a longitudinal direction of microchannel absorber 500 is orthogonal. According to other embodiments, baffles 520 extend along the length of microchannel absorber 500. As shown in FIG. 13, voids 530 are formed between plates 510. Baffles 520 may have a shape that corresponds with the shape and arrangement of plates 510. According to the embodiment shown in FIG. 13, voids 530 are triangular, and baffles 520 have a corresponding triangular shape. Baffles 520 may include a reflective material to reduce solar absorption or may include an absorptive material to reduce reflection and increase heat transfer therethrough, according to various embodiments. Baffles 520 may be directly attached to plates 510 or may be otherwise coupled to a structure of the receiver associated with microchannel absorber 500. In still other embodiments, plates 510 are themselves at least one of shaped and positioned to disrupt air flow along outer surfaces thereof (e.g., plates 510 may be staggered, plates 510 may have one or more surface features, etc.).

According to one embodiment, a receiver includes an adjuster coupled to at least one of a first panel and a second panel. In some embodiments, the adjuster is also coupled to a structure and actuates the panels between a first position and a second position. By way of example, the adjuster may change an angular offset between the panels, thereby changing an absorption profile of the solar absorber with which the panels are associated.

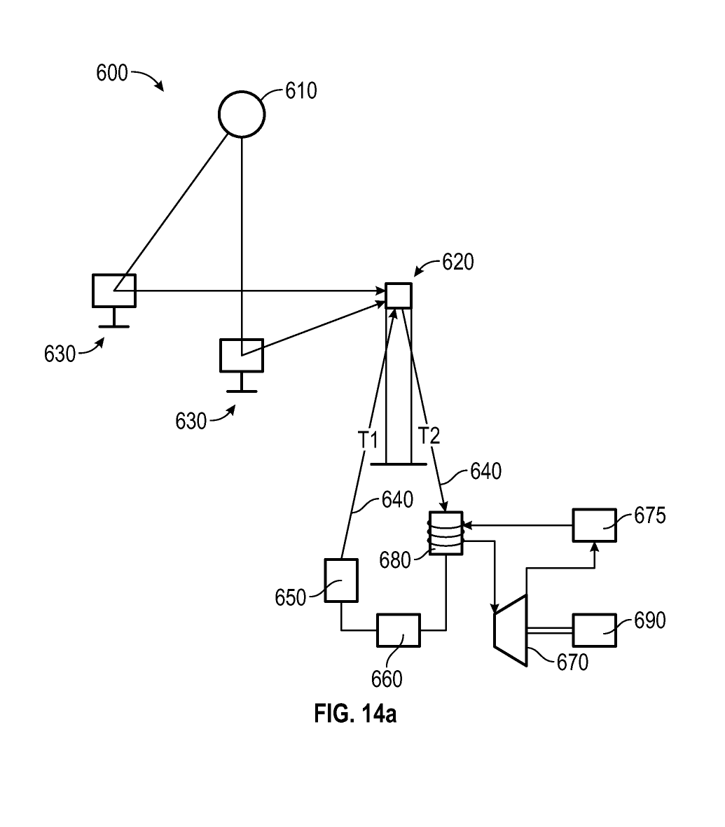

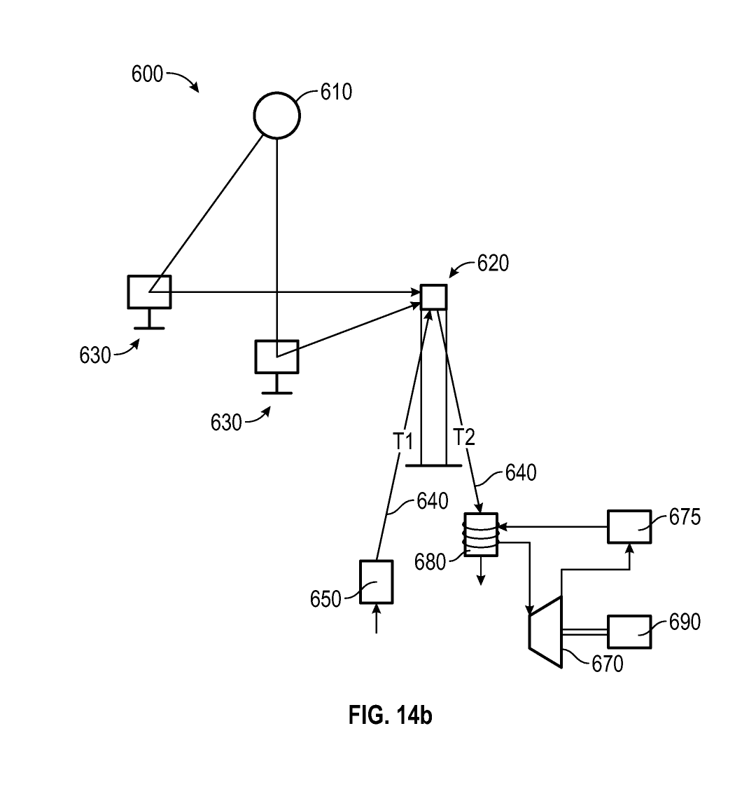

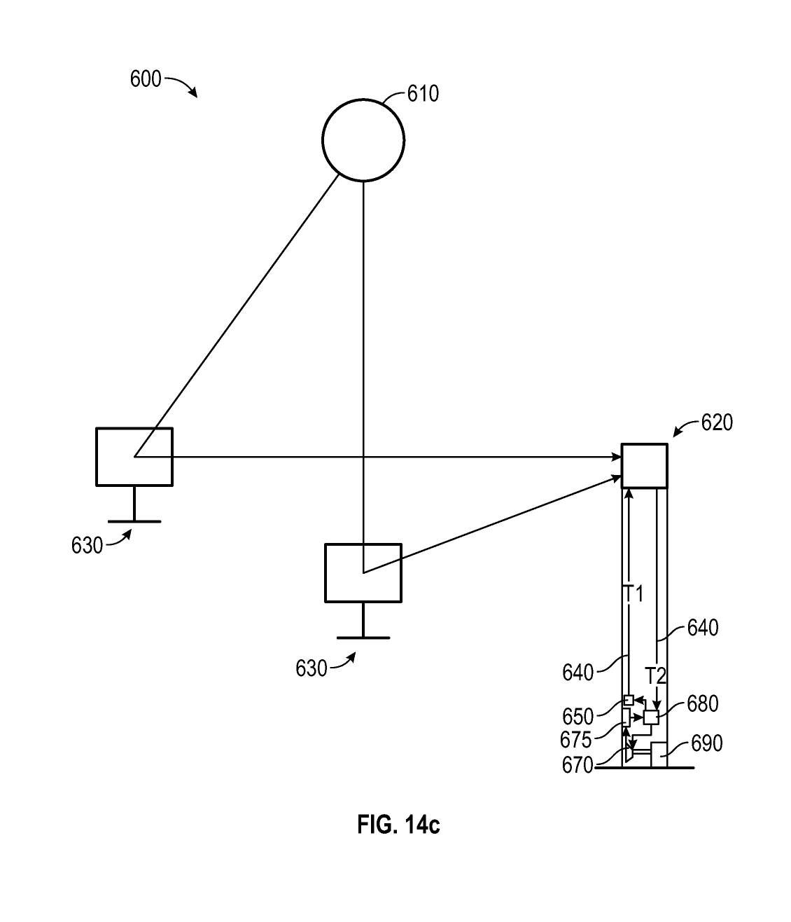

Referring next to the embodiment shown in FIGS. 14a-14c, an energy absorption system, shown as generation system 600, converts energy from sun 610 into electricity. As shown in FIGS. 14a-14c, generation system 600 has a solar receiver that includes a solar absorber, shown as solar absorber 620. According to one embodiment, generation system 600 includes a solar collector, shown as solar collector 630. As shown in FIGS. 14a-14c, solar collector 630 includes a plurality of heliostats configured to direct incident electromagnetic waves toward solar absorber 620 as reflected electromagnetic waves. The reflected electromagnetic waves from the plurality of heliostats together form a concentrated electromagnetic beam. According to another embodiment, solar collector 630 is another type of solar device (e.g., an imaging concentrator, a parabolic trough, a cylindrical trough, a non-imaging concentrator, a compound parabola solar collector, a light guide, a lens, an array of lenses, a mirror, an array of mirrors, etc.). Lenses, light guides, mirrors, or other optical manipulators may redirect sunlight toward solar absorber 620.

As shown in FIGS. 14a-14c, generation system 600 includes flow device 650 (e.g., compressor, pump, etc.) that directs a working fluid through tubing, shown as piping 640, in a flow path through solar absorber 620. In some embodiments, flow device 650 is an axial pump. In other embodiments, flow device 650 is a centrifugal pump. In still other embodiments, the working fluid is otherwise flowed through solar absorber 620. According to one embodiment, piping 640 defines an inlet end coupled to flow device 650, and flow device 650 provides a pressurized fluid flow thereto. As shown in FIG. 14a, generation system 600 includes container 660 to store the working fluid. According to the embodiment shown in FIG. 14a, the working fluid flows through piping 640 as part of a closed system. According to the embodiment shown in FIG. 14b, the working fluid is air and flows through piping 640 as part of an open system (i.e., air may be taken from a surrounding environment, heated through solar absorber 620, and ultimately returned to the surrounding environment, etc.). The air may be cooled before being returned to the surrounding environment.

Referring still to the embodiment shown in FIGS. 14a-14c, generation system 600 includes a generator, shown as turbine 670. According to one embodiment, the working fluid is delivered from solar absorber 620 to turbine 670 (e.g., the working fluid is water that is converted to steam in solar absorber 620, which is used within turbine 670, etc.). According to the embodiment shown in FIGS. 14a-14c, the working fluid is provided by flow device 650 to solar absorber 620 at a temperature T₁ and reaches a heat exchanger, shown as heat exchanger 680, at a higher temperature T₂. The higher-temperature working fluid transfers energy to a secondary fluid in heat exchanger 680, thereby increasing the temperature of the secondary fluid.

The secondary fluid is directed through heat exchanger 680 with flow device 675 (e.g., pump, compressor, etc.). According to one embodiment, the secondary fluid is water and enters heat exchanger 680 in liquid form and exits as steam. The secondary fluid may enter turbine 670 where it interacts internal turbine blades to rotate a turbine shaft. As shown in FIGS. 14a-14c, the turbine shaft turns a generator, shown as electrical generator 690. In some embodiments, the secondary fluid interacts with a cooling system (e.g., cooling towers, cooling fans, etc.) where energy is expelled to the surrounding environment before the secondary fluid again enters flow device 675 (e.g., to reduce the risk of steam entering flow device 675, etc.). According to one embodiment, turbine 670 also drives flow device 650 and/or flow device 675.

In some embodiments, turbine 670 is positioned at a ground level and solar absorber 620 is positioned at an elevation above the ground level (e.g., on a tower, etc.). In other embodiments, both turbine 670 and solar absorber 620 are coupled to a tower and positioned at an elevation above the ground level. As shown in FIG. 14c, various components of generation system 600 (e.g., turbine 670, heat exchanger 680, electrical generator 690, etc.) are integrated within a support structure to form a stand-alone solar power tower system. In other embodiments, at least a portion of the system is located remotely relative solar absorber 620.

According to another embodiment, generation system 600 includes an auxiliary heating source that replaces or supplements the provision of energy from sun 610 (e.g., during a cloudy day, at night, etc.). In some embodiments, the auxiliary heating source directs energy toward solar absorber 620. In other embodiments, the auxiliary heating source directly engages the working fluid. By way of example, the heating source may include a liquid or gaseous fuel positioned within the flow path of the working fluid. The liquid or gaseous fuel may transfer energy into the working fluid upon combustion. The auxiliary heating source may interact directly with solar absorber 620. In other embodiments, generation system 600 includes an auxiliary heat exchanger (e.g., a microchannel heat exchanger, etc.) with which the auxiliary heating source interacts to deposit energy into the working fluid. The auxiliary heat exchanger may be plumbed in series or parallel with solar absorber 620. In one embodiment, the auxiliary heat exchanger is plumbed in parallel with solar absorber 620, and generation system 600 includes one or more flow control devices (e.g., valves, etc.) positioned to vary a flow of the working fluid through solar absorber 620 and the auxiliary heat exchanger. The one or more flow control devices may be controlled using a processing circuit according to a flow control strategy. By way of example, the processing circuit may be configured to engage the one or more flow control devices to vary the flow through the auxiliary heat exchanger based on a temperature of the working fluid (e.g., as measured by a temperature sensor, etc.) at the outlet of solar absorber 620 (e.g., increase the flow through the auxiliary heat exchanger where the temperature of the working fluid at the outlet of solar absorber 620 falls below a threshold value, etc.). In other embodiments, the processing circuit is configured to engage the auxiliary heating source (e.g., vary a fuel supply to the auxiliary heating source, vary a damper or other adjustable element associated with the auxiliary heating source, etc.) to vary the amount of energy deposited into the working fluid (e.g., based on the temperature of the working fluid, etc.).

According to still another embodiment, a system is configured to directly utilize the energy introduced to the working fluid by the solar absorber. By way of example, the system may direct the working fluid over a material or product. The energy from the working fluid may be used to melt or otherwise heat the material or product (e.g., to facilitate a casting process, to heat treat the material, to sterilize the product, to evaporate water as part of a desalinization process, etc.). In other embodiments, the energy from the working fluid is used to facilitate a thermochemical process (e.g., to produce hydrogen from methane or water, to produce ammonia, to produce bio char, etc.).

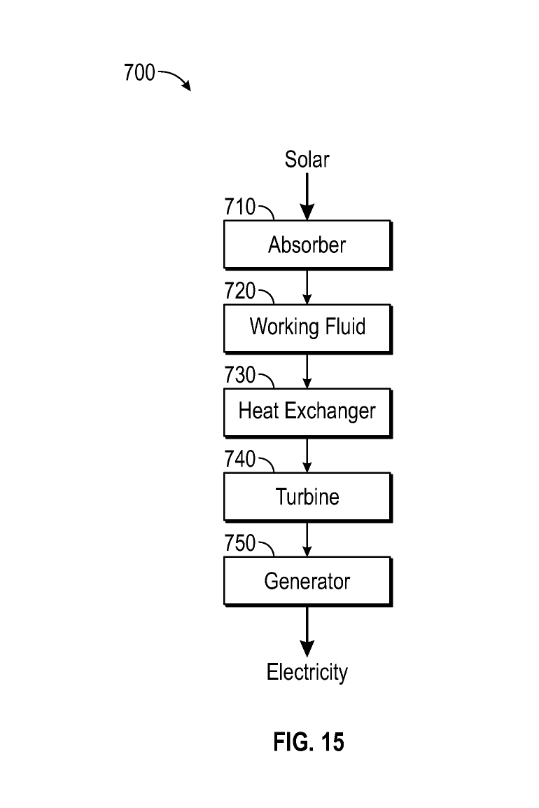

Referring to FIG. 15, energy flow diagram 700 is provided, according to one embodiment. As shown in FIG. 15, energy from sunlight is received into the generation system and interfaces with an absorber in step 710. Passages within panels of the absorber convert energy from sunlight into thermal energy and transfer the thermal energy to a working fluid in step 720. The working fluid transfers energy to a secondary fluid within a heat exchanger in step 730. The secondary fluid engages a turbine in step 740 where thermal energy from the secondary fluid is converted into mechanical energy. Mechanical energy is converted into electrical energy in step 750 such that electricity is provided by the generation system.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

It is important to note that the construction and arrangement of the elements of the systems and methods as shown in the embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present inventions. The order or sequence of any process or method steps may be varied or re-sequenced according to another embodiments. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the spirit of the appended claims.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A solar absorber, comprising:
a panel having an outer surface configured to absorb an incident concentrated broad spectrum visible solar radiation;
an inlet port;
an outlet port; and
a plurality of channels defined within the panel that form a flow path between the inlet port and the outlet port, wherein the plurality of channels are sized to facilitate laminar flow of a working fluid therethrough.

2. The solar absorber of claim 1, wherein the panel comprises an absorbing material such that the outer surface is configured to absorb the incident concentrated broad spectrum visible solar radiation.

3. (canceled)

4. The solar absorber of claim 1, wherein the outer surface comprises a surface treatment configured to facilitate absorbing the incident concentrated broad spectrum visible solar radiation.

5. (canceled)

6. The solar absorber of claim 1, wherein the outer surface comprises a coating configured to absorb the incident concentrated broad spectrum visible solar radiation.

7-8. (canceled)

9. The solar absorber of claim 6, wherein the coating is configured to absorb the incident concentrated broad spectrum visible solar radiation within a predetermined wavelength range, wherein the coating has a first emissivity for the predetermined wavelength range, and wherein the coating has a second emissivity lower than the first emissivity for wavelengths longer than the predetermined wavelength range.

10-20. (canceled)

21. The solar absorber of claim 1, further comprising a working fluid disposed within the plurality of channels.

22-26. (canceled)

27. The solar absorber of claim 21, wherein the plurality of channels are sized such that a fluid flow therethrough is laminar.

28-39. (canceled)

40. A solar receiver, comprising:
a frame;
an inlet manifold;
an outlet manifold; and
an absorber, comprising:
a first panel coupled to the frame, the first panel having an outer surface configured to absorb an incident concentrated broad spectrum visible solar radiation, wherein the first panel defines a plurality of channels; and
a second panel coupled to the frame, the second panel having an outer surface configured to absorb the incident concentrated broad spectrum visible solar radiation, wherein the second panel defines a plurality of channels,
wherein the first panel and the second panel each have an inner end that is coupled to the outlet manifold and an outer end that is coupled to the inlet manifold, wherein the first panel and the second panel are arranged in a V-shaped orientation thereby reducing radiative heat loss.

41. The solar receiver of claim 40, wherein at least one of the first panel and the second panel comprises an absorbing material such that the outer surface is configured to absorb the incident concentrated broad spectrum visible solar radiation.

42. The solar receiver of claim 41, wherein the absorbing material comprises graphite.

43. The solar receiver of claim 40, wherein the outer surface of at least one of the first panel and the second panel comprises a surface treatment configured to facilitate absorbing the incident concentrated broad spectrum visible solar radiation.

44. The solar receiver of claim 43, wherein the surface treatment comprises an etching.

45. The solar receiver of claim 40, wherein the outer surface of at least one of the first panel and the second panel comprises a coating configured to absorb the incident concentrated broad spectrum visible solar radiation.

46-47. (canceled)

48. The solar receiver of claim 45, wherein the coating is configured to absorb the incident concentrated broad spectrum visible solar radiation within a predetermined wavelength range, wherein the coating has a first emissivity for the predetermined wavelength range, and wherein the coating has a second emissivity lower than the first emissivity for wavelengths longer than the predetermined wavelength range.

49-59. (canceled)

60. The solar receiver of claim 40, further comprising a working fluid disposed within the plurality of channels of the first panel and the second panel.

61. The solar receiver of claim 60, wherein the working fluid comprises a gas.

62. (canceled)

63. The solar receiver of claim 60, wherein the working fluid comprises a liquid.

64-65. (canceled)

66. The solar receiver of claim 60, wherein the plurality of channels are sized such that a fluid flow therethrough is laminar.

67-79. (canceled)

80. The solar receiver of claim 40, wherein the first panel is angularly offset from the second panel.

81. (canceled)

82. The solar receiver of claim 40, wherein the first panel includes: a first subpanel having an inlet and an outlet; and a second subpanel having an inlet and an outlet, wherein the inlet of the first subpanel is coupled to the inlet manifold, wherein the outlet of the first subpanel is coupled to the inlet of the second subpanel, and wherein the outlet of the second subpanel is coupled to the outlet manifold.

83. The solar receiver of claim 82, wherein the first panel and the second panel comprise different materials.

84. The solar receiver of claim 83, wherein the first panel comprises a material configured to operate at a first temperature, and wherein the second panel comprises a material configured to operate at a second temperature greater than the first temperature.

85. The solar receiver of claim 40, further comprising a baffle disposed between the first panel and the second panel and configured to reduce convective heat loss.

86-88. (canceled)

89. A solar heating system for increasing the temperature of a fluid, comprising:
a solar receiver configured to convert an incident concentrated broad spectrum visible solar radiation into thermal energy, the solar receiver comprising:
a frame; and
an absorber including a panel coupled to the frame, the panel having an outer surface configured to absorb the incident concentrated broad spectrum visible solar radiation, wherein the panel defines a plurality of channels that are sized to facilitate laminar flow of a working fluid therethrough;
a piping system including:
an inlet manifold coupled to the solar receiver and configured to provide a gas input thereto; and
an outlet manifold coupled to the solar receiver and configured to receive a gas output therefrom, the piping system and the plurality of channels defining a flow path; and
a gas turbine coupled to the outlet manifold of the piping system and configured to convert the gas output into electricity.

90. The solar heating system of claim 89, further comprising a tower coupled to a ground interface and extending toward a distal end.

91. The solar heating system of claim 90, wherein the solar receiver is coupled to the distal end of the tower.

92. The solar heating system of claim 89, further comprising a solar concentrator that directs the incident concentrated broad spectrum visible solar radiation toward the solar receiver.

93-108. (canceled)

109. The solar heating system of claim 89, further comprising a flow device in fluid communication with the flow path, wherein the flow device is configured to provide a pressurized fluid flow to the inlet manifold of the piping system.

110. The solar heating system of claim 109, further comprising a working fluid disposed within the flow path.

111. (canceled)

112. The solar heating system of claim 110, further comprising a heat exchanger coupling the gas turbine to the outlet manifold.

113. The solar heating system of claim 112, wherein the gas turbine is in fluid communication with the heat exchanger.

114-122. (canceled)

123. The solar heating system of claim 89, further comprising an auxiliary heating source.

124. The solar heating system of claim 123, wherein the auxiliary heating source is configured to transfer heat into the working fluid via the panel.

125. The solar heating system of claim 123, wherein the auxiliary heating source is configured to transfer heat to the working fluid via a separate heat exchanger.

126. The solar heating system of claim 123, wherein the auxiliary heating source is configured to directly heat the working fluid.

127-266. (canceled)
